(19) United States
(12) Patent Application Publication
(10) Pub. No.: US 2007/0150537 A1
(43) Pub. Date: Jun. 28, 2007

(54) Social network e-commerce and advertisement tracking system

(76) Inventor: Brian Tyrone Graham, West Hollywood, CA (US)

Correspondence Address: LAW OFFICE OF J. CURTIS EDMONDSON, P.O. BOX 571, CLAREMONT, CA, 91711, US

(21) Appl. No.: 11/413,259

(22) Filed: Apr. 28, 2006

Related U.S. Application Data
(60) Provisional application No. 60/753,823, filed on Dec. 24, 2005.

(51) Int. Cl. G06F 15/16

(52) U.S. Cl. 709/203

(57) ABSTRACT

The present invention relates to methods of advertising, social networking systems, and individualized profiles located within social networking systems. According to a first aspect of the present invention, a method of advertising within a Social Networking System is provided, which is carried out by providing a group of users with access to a Social Networking System, wherein the Social Networking System provides each of its users with individualized profiles. The method further includes providing at least one “Social Network E-Commerce and Advertisement Tracking System” (referred to herein as “SNEATS” or “SNEATS server”), wherein the SNEATS server provides each user of the Social Networking System with the ability to access and incorporate one or more advertising objects into his or her individualized profile. In other embodiments, the SNEATS server provides third party vendors with the ability to access and incorporate one or more advertising objects into a user's individualized profile, provided such advertising objects are acceptable to such user. Upon incorporating an advertising object into an individualized profile, users of the Social Networking System may activate such advertising object, which causes an advertising scheme to be launched (e.g., an image, flash file, or secondary website) that promotes a particular good or service. The invention provides that, upon activating such advertising object, the user affiliated with the individualized profile that contains such advertising object is awarded advertising revenue.

### CROSS-REFERENCE TO RELATED APPLICATIONS

This application claims the benefit of U.S. provisional patent application Ser. No. 60/753,823, filed Dec. 24, 2005, which is incorporated herein by reference.

### FIELD OF THE INVENTION

The present invention relates generally to methods of advertising, social networking systems, and individualized profiles located within social networking systems.

### BACKGROUND OF THE INVENTION

Social Networking Systems encompass certain on-line services that provide a group of individuals with the ability to collaborate with each other over the internet. Examples of Social Networking Systems may be found at “myspace.com”, “friendster.com”, and “tribe.net”. Social Networking Systems generally consist of an on-line social network, which is represented by a map of the relationships between individuals. The social network, or map of relationships, indicates the ways in which such individuals are connected through various social familiarities ranging from casual acquaintance to close familial bonds.

The social networks represent both a collection of ties between people and the strength of those ties. Such networks are often used as a measure of social “connectedness”. In addition, social networks assist individuals in determining how information moves throughout groups, and how trust may be established and fostered.

In recent years, Social Networking Systems have gained immense popularity and attracted millions of individual users. Many Social Networking Systems allow individuals to use and participate in such Social Networking Systems at little to no cost. In order to generate revenue to support the operation of such on-line activity, a number of Social Networking Systems publish banner advertisements within portions of the user interface (i.e., the owners of Social Networking Systems often sell advertising space within portions of the user interface). Although banner advertisements have provided owners and operators of Social Networking Systems with a minimum level of advertising revenue, improved methods and advertising products are needed to enable such owners and operators to generate additional advertising revenue.

In addition, there is no currently-available method by which users of Social Networking Systems may generate revenue from their participation in such programs. Thus, there is also a need for methods that enable users of Social Networking Systems to generate revenue from their participation in such programs. As the following will demonstrate, many of the foregoing needs and market demands are provided by the present invention.

### SUMMARY OF THE INVENTION

According to a first aspect of the present invention, a method of advertising within a Social Networking System is provided. In certain embodiments, the method is carried out by providing a group of users with access to a Social Networking System, wherein the Social Networking System provides each of its users with individualized profiles. The method further includes providing at least one “Social Network E-Commerce and Advertisement Tracking System” (referred to herein as “SNEATS” or “SNEATS server”), wherein the SNEATS server provides each user of the Social Networking System with the ability to access and incorporate one or more advertising objects into his or her individualized profile. In related embodiments, the SNEATS server allows third party vendors to incorporate one or more advertising objects into an individualized profile, provided that such advertising objects satisfy the criteria established by the user associated with such individualized profile. Upon incorporating an advertising object into an individualized profile, users of the Social Networking System may activate such advertising object, which causes an advertising scheme to be launched (e.g., an image, flash file, “pop up” ad, or secondary website) that promotes a particular good or service.

The Social Networking System may be hosted within the SNEATS server, or, alternatively, in a separate server that is capable of exchanging information, directly or indirectly, with the SNEATS server. In the event that a user (or third party vendor) incorporates one or more advertising objects into an individualized profile, the user associated with the individualized profile may be awarded advertising revenue in consideration thereof (as described further below). Such advertising revenue may be awarded by the vendor associated with the advertising object and/or by the owner/operator of the SNEATS server. In addition, such advertising revenue may be paid in various forms, including as a flat-fee upon incorporating an advertising object and/or on a “pay-per-click” basis (as described further below).

According to another aspect of the invention, systems are provided that may be used to advertise any of various goods or services within a Social Networking System. In certain preferred embodiments, the system comprises a Social Networking System that includes a plurality of users, a plurality of user terminals, and at least one server responsible for hosting the Social Networking System. The Social Networking System provides each of its users with individualized profiles, which are capable of incorporating at least one advertising object therein.

The system further includes at least one SNEATS server, wherein the SNEATS server (i) is capable of exchanging information with the server responsible for hosting the Social Networking System and (ii) provides each user of the Social Networking System with the ability to access and incorporate one or more advertising objects into his or her individualized profile. In related embodiments, the SNEATS server allows third party vendors to incorporate one or more advertising objects into an individualized profile, provided that such advertising objects satisfy the criteria established by the user associated with such individualized profile. Similar to other embodiments of the invention, the Social Networking System may be hosted within the SNEATS server, or in a separate server that is capable of exchanging information, directly or indirectly, with the SNEATS server. The system further provides a mechanism by which a user is awarded advertising revenue in the event that one or more advertising objects are incorporated within his or her individualized profile.

The methods and systems of the present invention provide various means by which users of the Social Networking System, and/or third party vendors, may incorporate one or more advertising objects into individualized profiles. For example, in one embodiment of the invention, a SNEATS server provides a user with a menu of different advertising objects that are sponsored by a number of vendors. Each advertising object may have different qualities, such as the type of media that is used to carry out an advertising scheme, the amount of potential advertising revenue that the user may be awarded upon incorporating the advertising object (as well as the methods by which such revenue is awarded), the types of goods and services that are promoted in connection with the advertising object, and others. In such embodiment, upon selecting the desired advertising object, the object is incorporated within the user's individualized profile (and made available to the other users of the Social Networking System to activate).

In other embodiments of the invention, the methods and systems described herein provide various means by which users of the Social Networking System may allow vendors to directly incorporate one or more advertising objects into their individualized profiles. For example, if a user elects to allow vendors to incorporate one or more advertising objects into his or her individualized profile, such election may be made through the SNEATS server, which further allows the user to dictate the types of advertising objects that are acceptable and/or unacceptable to the user. Still further, the SNEATS server may provide the user with the opportunity to expressly accept the incorporation of a particular advertising object by a vendor—before such object is incorporated into his or her individualized profile.

The above-mentioned and additional features of the present invention are further illustrated in the Detailed Description contained herein. All references disclosed herein, including U.S. patents and patent applications, are hereby incorporated by reference in their entirety as if each was incorporated individually.

### BRIEF DESCRIPTION OF THE DRAWINGS

FIG. 1: A diagram showing a non-limiting example of the steps that are carried out using the methods and systems of the present invention, wherein a user is awarded advertising revenue on a “pay-per-click” basis.

FIG. 2: A diagram showing a non-limiting example of the steps that are carried out using the methods and systems of the present invention, wherein a user is awarded advertising revenue upon incorporating an advertising object into his or her individualized profile and on a “pay-per-click” basis.

FIG. 3: A diagram showing a non-limiting example of the steps that are carried out using the methods and systems of the present invention, wherein an advertising scheme is immediately launched when an associate user selects another user's individualized profile.

FIG. 4: A diagram showing a non-limiting example of the steps that are carried out using the methods and systems of the present invention, wherein a SNEATS server compares information that is present within an associate user's individualized profile to criteria that are established for an advertising object. If the associate user's profile satisfies such criteria, the associate user has the option to select the advertising object, thereby causing an advertising scheme to be launched.

FIG. 5: A diagram showing a non-limiting example of the steps that are carried out using the methods and systems of the present invention, wherein a SNEATS server compares information that is present within an associate user's individualized profile to criteria that are established for an advertising object. If the associate user's profile satisfies such criteria, an advertising scheme is automatically launched.

FIG. 6: A diagram showing a non-limiting example of the steps that are carried out using the methods and systems of the present invention, particularly showing a method by which a user may directly incorporate an advertising object into his or her individualized profile.

FIG. 7: A diagram showing a non-limiting example of the steps that are carried out using the methods and systems of the present invention, particularly showing a method by which a vendor may directly incorporate an advertising object into a user's individualized profile (provided that the advertising object satisfies the criteria set by such user).

FIG. 8: A diagram showing a non-limiting example of the steps that are carried out using the methods and systems of the present invention, particularly showing a method by which a vendor may incorporate an advertising object into a user's individualized profile—provided that such user expressly consents to the incorporation of such advertising object into his or her individualized profile.

FIG. 9: A non-limiting example of a website that may be used to establish an individualized profile.

FIG. 10: Another portion of the website of FIG. 9.

FIG. 11: Another portion of the website of FIG. 9.

FIG. 12: A non-limiting example of a website that may be used to certify an individualized profile.

FIG. 13: A non-limiting example of a website that may be used to sell advertising space within an individualized profile.

FIG. 14: Another portion of the website of FIG. 13.

FIG. 15: Another portion of the website of FIG. 13.

FIG. 16: A non-limiting example of a website that provides potential buyers of advertising space with a menu of different individualized profiles from which to choose.

FIG. 17: A non-limiting example of a website comprising a searchable collection or directory of individualized profiles.

FIG. 18: Another portion of the website of FIG. 17.

### DETAILED DESCRIPTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to a first aspect of the present invention, a method of advertising within a Social Networking System is provided (the term “Social Networking System” may be abbreviated herein as “SNS”). The term “Social Networking Systems” generally refers to on-line services that provide a group of individuals with the ability to collaborate with each other over the internet. Examples of such services may be found at “myspace.com”, “friendster.com”, and “tribe.net”. Social Networking Systems often include a social network, which represents a map of the relationships between individuals. The social network, or map of relationships, indicates the ways in which such individuals are connected through various social familiarities ranging from casual acquaintance to close familial bonds.

In certain embodiments of the present invention, the methods of advertising within a Social Networking System are carried out by providing a group of users with access to a Social Networking System, wherein the Social Networking System provides each of its users with individualized profiles. The methods further include providing at least one “Social Network E-Commerce and Advertisement Tracking System” (referred to herein as “SNEATS” or “SNEATS server”), wherein the SNEATS server provides each user of the Social Networking System with the ability to access and incorporate one or more advertising objects into his or her individualized profile. In other, preferred embodiments of the invention, the SNEATS server allows third party vendors to incorporate one or more advertising objects into such individualized profiles, provided that such advertising objects satisfy the criteria established by the users associated with such individualized profiles. The invention provides that a Social Networking System may be hosted within the SNEATS server, or, alternatively, in a separate server that is capable of exchanging information, directly or indirectly, with the SNEATS server.

The term “individualized profile” refers to a collection of information and/or images relating to a particular user. For example, such information may consist of a user's first name, last name, username for accessing the Social Networking System, gender, age, area of residence, education, profession, and/or description of his or her interests. In addition, an individualized profile may include a field in which the applicable user may enter any text of his or her choosing, such as a general description of his or her interests and hobbies. Furthermore, an individualized profile may have other forms of media associated with it, such as an image, a video clip, an audio clip, and/or hyperlink featuring or associated with the applicable user.

The information and other media associated with an individualized profile are maintained within the server that hosts the Social Networking System. The methods by which users of Social Networking Systems provide such information and other media to a server are well known to those of ordinary skill in the art. For example, such information and other media may be entered into an on-line form that is made available over the internet through a website associated with a Social Networking System.

An on-line form may include text boxes into which a user enters various information, such as his or her first and last name. In addition, an on-line form may request and gather information using “drop boxes” (e.g., to specify the user's age, state of residence, profession, etc.) or “button menus” (e.g., to specify the user's gender) or other HTML (hypertext markup language) form components known in the art. An on-line form may also provide a user with the ability to enter any free text of his or her choice into a “text area,” which are not typically limited to a certain number of characters (unlike a “text box”). Furthermore, the on-line form that is used to establish an individualized profile (a.k.a., an individualized profile application form) may provide users with the ability to “upload” an image, a video clip, and/or an audio clip to the server that hosts the Social Networking System—which will be published within or in connection with the user's individualized profile. Similarly, such on-line forms may allow users to incorporate hyperlinks into individualized profiles, such as a hyperlink to a personalized website that a user has established.

As described above, a Social Networking System will consist of an on-line social network comprising a plurality of individualized profiles, wherein each profile is created by separate individual users. In certain preferred embodiments, a user of the Social Networking System will be able to locate a particular user by referring to (or searching for) a particular area within the social network.

In addition, the Social Networking System will preferably include a means by which a user may conduct a search for other users, such as by using “keyword” or boolean-type searching. As used herein, an “associate user” refers to a user of a Social Networking System that searches—using any suitable means—for another user (or group of users) of the Social Networking System. For example, a Social Networking System may include a website that allows associate users to enter certain keywords into a search field and query the contents of the individualized profiles of other users (which are maintained within the server that hosts the Social Networking System). Upon submitting a keyword search, for example, the Social Networking System may query certain “searchable fields” of individualized profiles—the contents of which are filled with information provided by each respective user, e.g., the fields described above relating a user's first name, last name, gender, age, area of residence, education, profession, and/or general interests. Those of ordinary skill in the art will appreciate that any of various means could be used to provide associate users with the ability to narrow or broaden the search for other users.

As mentioned above, the SNEATS server provides each user of the Social Networking System with the ability to access and incorporate one or more advertising objects into his or her individualized profile. In other preferred embodiments of the invention, the SNEATS server enables third party vendors to incorporate advertising objects into such individualized profiles, provided that such advertising objects satisfy the criteria established by the users associated with such individualized profiles. As used herein, an “advertising object” refers an executable portion of an individualized profile, wherein upon executing (a.k.a., activating or selecting) the advertising object, an “advertising scheme” is launched. The advertising object may be represented as an image, icon, hyperlink, or other computer-readable element that an associate user may select (or “click”) upon viewing a user's individualized profile in which the advertising object resides. The advertising object may consist of various types of computer-readable code, such as JAVA, PHP, HTML, or combinations thereof. For example, an advertising object may consist of particular JAVA scripts that are executed upon an associate user “clicking” an image that is located within an individualized profile (wherein the exact location of such image within the individualized profile is dictated by HTML language). Such computer-readable code will reside within the SNEATS server.

The term “advertising scheme” refers to an on-line promotion, advertisement, or other viewing that is launched (i.e., published) within an individualized profile upon activating a particular “advertising object” located therein. Alternatively, an advertising scheme may be launched in a secondary website upon activating a particular “advertising object” located within an individualized profile, e.g., a “pop-up ad”. An advertising scheme may employ any of various forms of media, such as images, animation clips, flash files, video clips, audio clips, separate websites, or any combination of the foregoing. The computer-readable code that executes and enables the launching and viewing of an advertising scheme will reside within the SNEATS server.

In certain embodiments, an advertising scheme may further comprise one or more gift cards, gift certificates, and/or coupons offered by the vendor that sponsors the advertising object/advertising scheme. The gift cards, gift certificates, and/or coupons may be downloaded or printed directly from the advertising scheme (i.e., the website in which the advertising scheme is published). Still further, the gift cards, gift certificates, and/or coupons may be redeemed directly over the internet. For example, the coupon may comprise a hyperlink (hidden or visible), wherein a user may exercise such coupon by “clicking” on the coupon which directs the user to a certain internet address maintained by the respective vendor (which allows the user to, directly or indirectly, redeem the coupon).

In other embodiments, the gift cards, gift certificates, and/or coupons may be downloaded and/or printed directly from the advertising scheme. Preferably, the gift cards, gift certificates, and/or coupons include authenticating information, such as alphanumeric identifiers, UPC symbols or “bar codes” that may be “scanned” using methods well-known in the art, watermarks, or other authenticating means (currently existing or discovered hereafter).

It is contemplated that some users of the internet may not have sufficient, or preferred, software for viewing certain advertising schemes that may be launched from an advertising object located within a particular individualized profile. Accordingly, the individualized profiles (or website associated therewith) may, optionally, provide the software to such users for download. Of course, the software may be offered to such users free of charge or, alternatively, for a fee. For example, Imaging for Windows® software may be used to view digital images (which is provided to Microsoft Corporation by Eastman Software, Inc.); Adobe® Reader® may be used to view documents in portable document format (PDF) (available from Adobe Systems, Inc., San Jose, Calif., USA); and Macromedia Flash Player and Macromedia Shockwave Player (available from Macromedia, Inc., San Francisco, Calif., USA) may be used to view and listen to flash files and other video/audio clips. Alternatively, an individualized profile (or website associated therewith) may include a hyperlink to the organization (or other website) where such software may be purchased, downloaded, or otherwise accessed. The above software programs are referenced herein for illustration purposes only, and those of ordinary skill in the art will appreciate that other programs may be utilized.

As described above, the Social Networking System may enable an associate user to search for a specific individual user (e.g., by first name, last name, SNS username, etc.) or a certain type of user (e.g., by conducting keyword searches for individuals who may have an interest in a particular sport or live in a certain area). Upon conducting a search, the Social Networking System provides the associate user with search results, which may comprise (a) an individualized profile of a single user (e.g., in the case of a search based on a first name, last name, SNS username, etc.), (b) profiles for a plurality of users (e.g., in the case of a keyword search), or (c) no profiles (e.g., in the case where the keyword search did not find any matching content within the profiles queried). In the event that one or more users (i.e., individualized profiles of users) are identified from an associate user's search, the associate user will have the ability to select a particular user's individualized profile, wherein upon such selection the corresponding user's individualized profile is viewed (i.e., published within the website associated with the Social Networking System).

In the event that the selected individualized profile includes one or more advertising objects, the associate user may then execute (or activate) such advertising object, whereupon the SNEATS server directs the activation and publication of an advertising scheme. The SNEATS server records each time that a particular advertising object is activated. The SNEATS server may also record various types of information associated with each such activation, such as the individualized profile from which it was activated; the date and time at which it was activated; and the username (and/or identity) of the associate user that activated the object.

In certain embodiments of the invention, the user connected with the individualized profile—from which an advertising object is activated—is awarded advertising revenue (as a form of payment for allowing the vendor to advertise its goods or services within the user's individualized profile). Such advertising revenue may be awarded by the vendor associated with the advertising object and/or by the owner/operator of the SNEATS server. In such cases, the user connected with the individualized profile may be paid such advertising revenue on a “pay-per-click” basis (i.e., each time that the advertising object is activated). In other cases, the user connected with the individualized profile may be paid a one-time fee, which may accrue on a daily, weekly, or monthly basis.

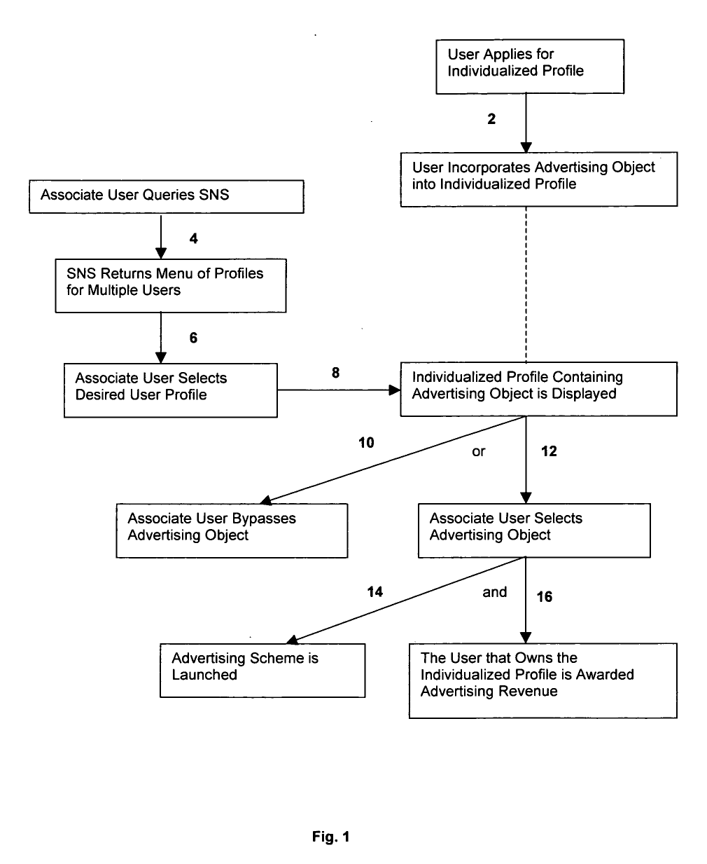

In order to further demonstrate this process, FIG. 1 shows a diagram that illustrates the steps that may be followed to carry out certain aspects of the invention. As shown therein, an individual user applies for and establishes an individualized profile (and is provided the option of incorporating an advertising object into his or her individualized profile 2). An associate user may then query the Social Networking System 4 using search logic of his or her choice, which may return search results containing a plurality of links to various individualized profiles. The associate user may then select the desired individualized profile 6 causing the profile to be displayed 8, which contains one or more advertising objects. In this example, the advertising object may comprise an image of a specific product, which is identified therein by the vendor's name and trademark. The associate user has the option to activate (or “click”) the advertising object (i.e., image).

If the associate user does not activate the advertising object 10, he or she is allowed to read, use, and/or interact with the individualized profile as needed (and the associate user is said to have “bypassed” the advertising object). If the associate user activates (or “clicks”) the advertising object 12, an advertising scheme is launched 14. In this example, upon activating the advertising scheme, a JAVA script is executed within the SNEATS server that directs the publication of a flash file within a secondary website. The associate user may view the advertising scheme (i.e., flash file) and subsequently close the file. In addition, the SNEATS server records the activation of such advertising object, so that the user connected with such individualized profile will be awarded advertising revenue 16 in accordance with the terms set by the applicable vendor.

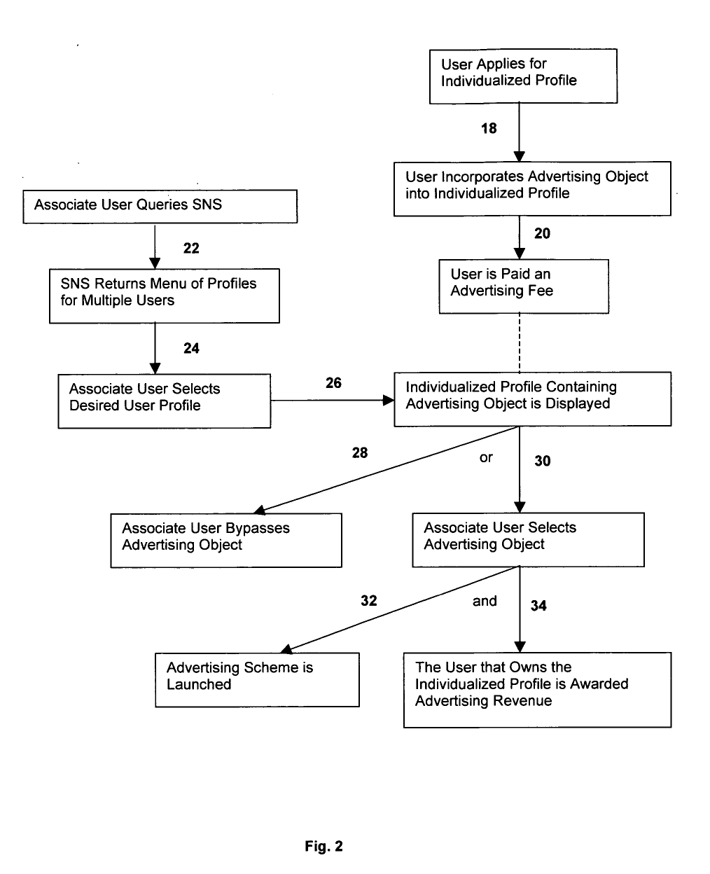

In another example of the present invention, a user may be paid a flat-fee upon incorporating an advertising object into his or her individualized profile (which may be in addition to, or in replacement of, advertising revenue that may be awarded upon activation of the advertising object by an associate user). For example, referring to FIG. 2, an individual user may apply for and establish an individualized profile (and is provided the option of incorporating an advertising object into his or her individualized profile 18). Upon incorporating an advertising object into his or her individualized profile, the user is paid a flat-fee 20 (i.e., an advertising fee). An associate user may then query the Social Networking System 22 using search logic of his or her choice, which may return search results containing a plurality of links to various individualized profiles. The associate user may then select the desired individualized profile 24 causing the profile to be displayed 26, which contains one or more advertising objects. If the associate user does not activate the advertising object 28, he or she may read, use, and/or interact with the individualized profile as needed (thereby bypassing the advertising object). If the associate user activates (or “clicks”) the advertising object 30, an advertising scheme is launched 32. In this example, the SNEATS server records the activation of such advertising object, so that the user connected with such individualized profile will also be awarded advertising revenue 34 in accordance with the terms set by the applicable vendor (i.e., on a “pay-per-click” basis).

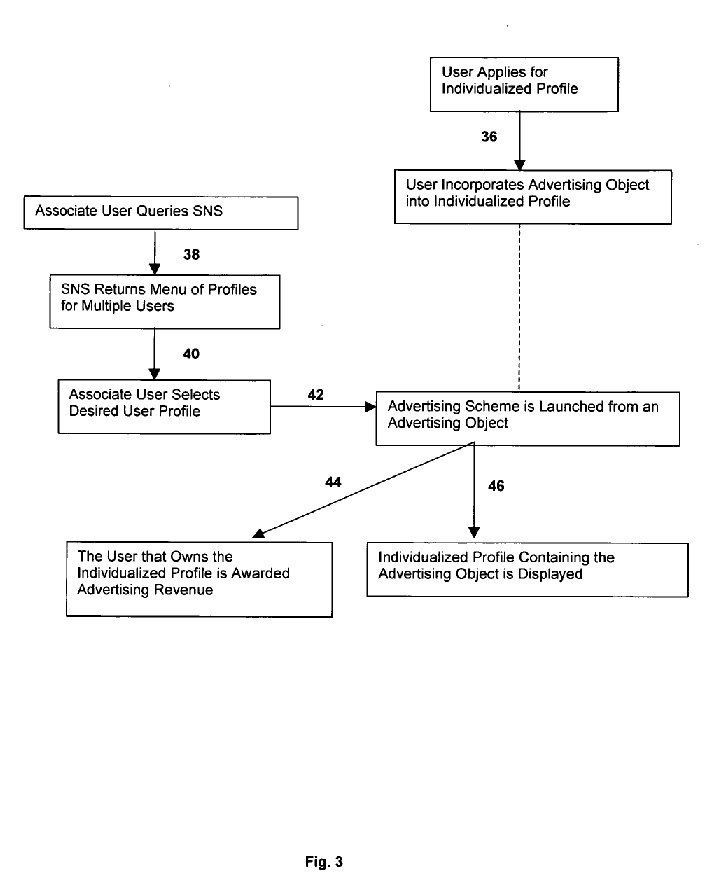

In another embodiment of the present invention, upon selecting a desired individualized profile from a list of search results, advertising schemes are immediately launched (such that an associate user may not bypass such advertising schemes). For example, referring to FIG. 3, upon selecting a desired individualized profile 40 from a list of search results, an advertising scheme is immediately launched 42. In this example, the advertising scheme may consist of an image promoting a certain product. The image may further contain a link, wherein upon “clicking” the link, the advertising scheme is closed and the associate user is transferred to the desired individualized profile 46. As shown in FIG. 3, the user affiliated with the selected individualized profile is awarded advertising revenue 44 in accordance with the applicable vendor's terms.

In still further embodiments, the SNEATS server analyzes the individualized profile of an associate user and, based on such information, determines whether an advertising object should be made available in an individualized profile that such associate user may select. More specifically, in certain embodiments of the invention, vendors may specify that only certain types of associate users be provided the option to activate its advertising objects. For example, in the event that a vendor desires to incorporate advertising objects (correlated to advertising schemes) that promote golf clubs, the vendor may specify that its advertising objects will only be made available (i.e., be visible and executable by associate users) if there is a reasonable likelihood that a viewing associate user plays golf. This analysis may be carried out by the SNEATS server conducting a search of certain “searchable fields” located within an associate user's individualized profile, such as by searching for the presence of the term “golf” within the content entered by the user into the “general interest” text area of an individualized profile application form (described above).

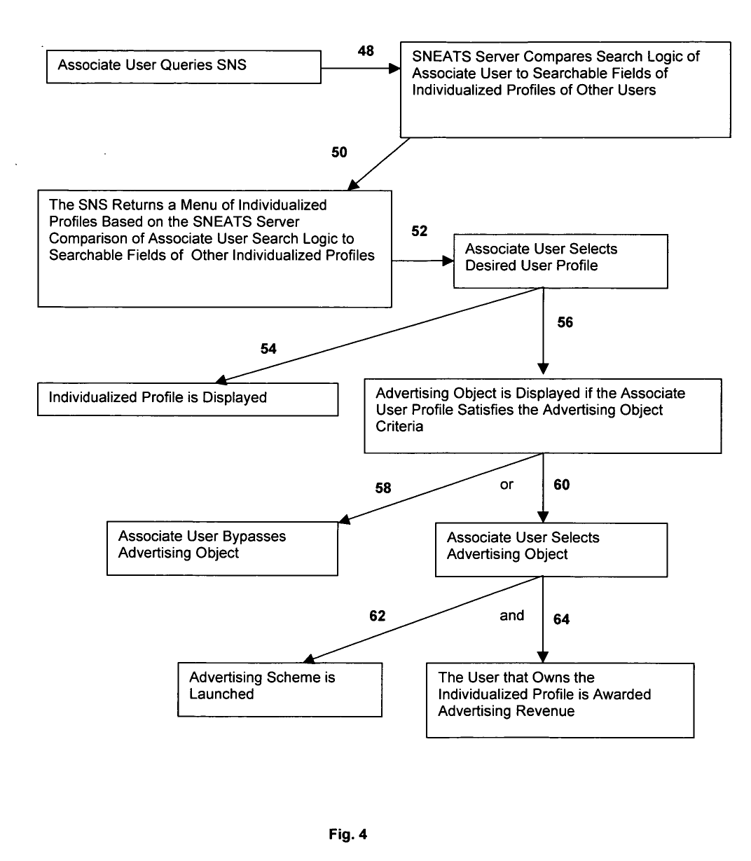

FIG. 4 illustrates this process. As shown therein, an associate user may search for one or more other users 48 using search logic of his or her choice. The SNEATS server uses this search logic to provide a list of search results 50, which comprises a listing of individualized profiles that are responsive to the associate user's search logic. The associate user is then allowed to select the desired individualized profile 52. If the profile of the associate user, such as the gender, age, location of residence, and/or interests of the associate user, satisfy the criteria established for a particular advertising object, the advertising object is displayed 56 within the selected individualized profile 54.

In this example, the advertising object is for a restaurant located in Denver, Colo. The vendor specified that the advertising object would only be included within an individualized profile if the associate user lived in the State of Colorado. Thus, if the associate user's profile shows that he or she lives in New York, the advertising object will not be displayed within the selected individualized profile 54. If the associate user's profile shows that he or she lives in Colorado, the advertising object is displayed 56 within the selected individualized profile 54. In this case, the associate user may bypass the advertising object 58 or select (i.e., activate) the advertising object, thereby launching an advertising scheme 62 (which further entitles the owner of the individualized profile to advertising revenue 64).

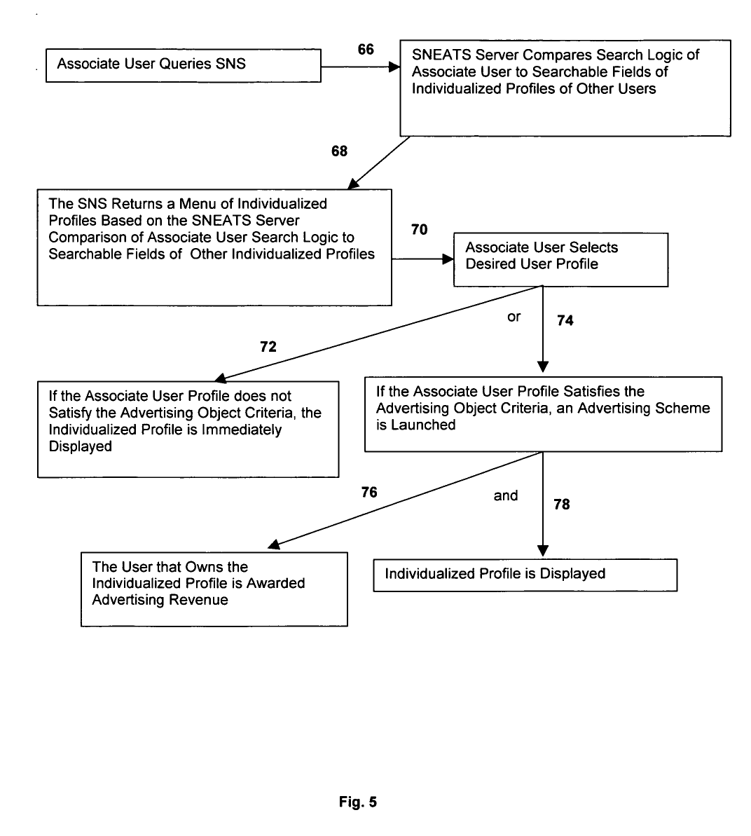

In certain related embodiments, referring to FIG. 5, upon selecting an individualized profile 70 containing an advertising object, if the associate user's profile satisfies the criteria set for the advertising object, an advertising scheme is immediately launched 74 (and the owner of the individualized profile is awarded advertising revenue 76). After the advertising scheme is launched and closed, the associate user is directed to the selected individualized profile 78. Of course, if the associate user's profile does not satisfy such criteria, the associate user is taken directly to the selected individualized profile 72.

As mentioned above, the SNEATS server records each time that a particular advertising object is activated and, preferably, the date and time at which it was activated and the username (and/or identity) of the associate user that activated the object. In certain embodiments, the SNEATS server stores this information for a defined period of time, such as for one month, six months, a year, or any other suitable period of time. The SNEATS server records and saves this type of information for numerous reasons, including to facilitate the payout of advertising revenue that is owed to various users. Of course, users that are owed advertising revenue in accordance with the present invention may be paid at specified time intervals, such as on a daily, weekly, monthly, or yearly basis. For example, in the case of a weekly time interval, a user may be paid for the total advertising revenue owed such user for the aggregate number of times that an advertising object was executed by associate users during the applicable week. Such advertising revenue may be paid to users through any suitable means, such as by check or by automatically depositing the amount due into a user's bank account (wherein the tracking and account numbers for such user's bank account are maintained within the SNEATS server).

In certain preferred embodiments, the SNEATS server provides a means by which a user may access his or her “advertising object account”. An advertising object account will preferably reflect the type(s) of advertising object(s) that are located within the user's individualized profile, the number of times that such object(s) was activated within a defined period of time, and the total amount of advertising revenue that is owed to such user. Preferably, users will access their advertising object accounts using secure and encrypted usernames and passwords, such that users will “log into” their accounts over a secure network.

As mentioned above, the SNEATS server preferably records the username (and/or identity) of each associate user that activates a particular advertising object. In certain embodiments of the invention, an advertising object located within a particular individualized profile may only be activated once by a specific associate user. For example, if the SNEATS server records that “associate user α” activated “advertising object β” located within “individualized profile γ”, after leaving or closing “individualized profile γ”, “associate user α” may not re-enter “individualized profile γ” and activate “advertising object β”. This way, the SNEATS server prevents a user from eliciting friends, e.g., associate users, to enter his or her individualized profile and repeatedly activate a particular advertising object in order to artificially inflate the amount of advertising revenue that such user is owed. Similarly, of course, the SNEATS server will detect if a user enters his or her own individualized profile, such that the user will not be provided the option of (or will not be compensated for) activating advertising objects located within his or her own individualized profile.

The methods and systems of the present invention provide various means by which users of the Social Networking System may incorporate one or more advertising objects into their individualized profiles. For example, in one embodiment of the invention, a SNEATS server provides a user with a menu of different advertising objects that are sponsored by a number of vendors. Each advertising object may have different qualities associated with it, such as (i) the identity of the vendor affiliated with each object, (ii) the type of media that is used to carry out the corresponding advertising scheme (e.g., whether the corresponding advertising scheme comprises an image, flash file, secondary website, coupon, etc.), (iii) the amount of potential advertising revenue that the user may be awarded upon incorporating the advertising object, (iv) the methods by which such revenue is awarded (e.g., whether a specified flat-fee is awarded immediately upon incorporating the object and/or whether revenue is awarded on a “pay-per-click” basis), (v) the types of goods and services that are advertised in connection with the advertising object, and (vi) any other qualities or characteristics that users would want to know about each advertising object. In addition, the menu of different advertising objects may be categorized in various ways to facilitate a user's search for and identification of desired advertising objects, such as by vendor, industries, types of goods and services, the form and amount of advertising revenue that may be awarded, and other characteristics.

Upon selecting a desired advertising object, the object is incorporated within the user's individualized profile (and made available to the other associate users of the Social Networking System to view and activate). The SNEATS server is responsible for hosting, among other things, (a) the variety of advertising objects that are available for users to incorporate within their individualized profiles, (b) the transferring of selected advertising objects into individualized profiles, (c) recording each time that an advertising object is activated, and (d) the advertising schemes that are launched from activated advertising objects. In addition, as described above, the SNEATS server may further host the Social Networking System (or, alternatively, the Social Networking System may be hosted on a separate server that is capable of interacting with the SNEATS server).

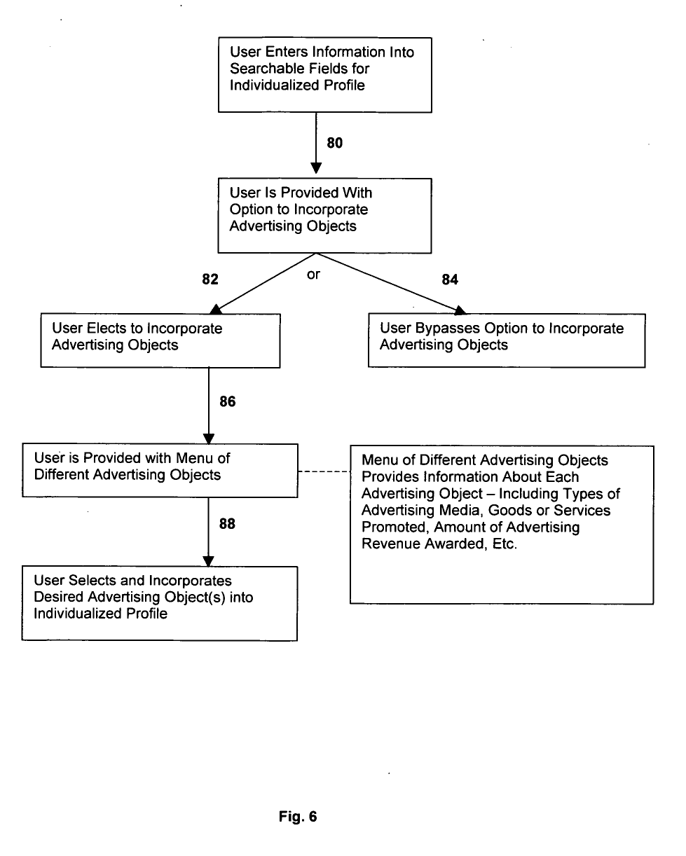

In order to further demonstrate the above methods, FIG. 6 further illustrates the steps that a user may take to incorporate an advertising object into his or her individualized profile. In this example, the user enters various types of information into searchable fields 80 of the individualized profile. The user is provided with the opportunity to incorporate one or more advertising objects into his or her individualized profile. If the user elects not to incorporate an advertising object 84, the user may be allowed to proceed and participate within the Social Networking System as usual. If the user desires to incorporate an advertising object into his or her individualized profile 82, the user is provided with a menu of advertising objects that are hosted within the SNEATS server 86. Preferably, the menu provides information related to each advertising object, such as the types of goods or services promoted by each object, the types of media that are used to launch the advertising schemes associated with each object, and the form and amount of adverting revenue that may be awarded to a user by incorporating each advertising object. Next, the user may select the desired advertising object 88, which directs the SNEATS server to incorporate such object within the user's individualized profile.

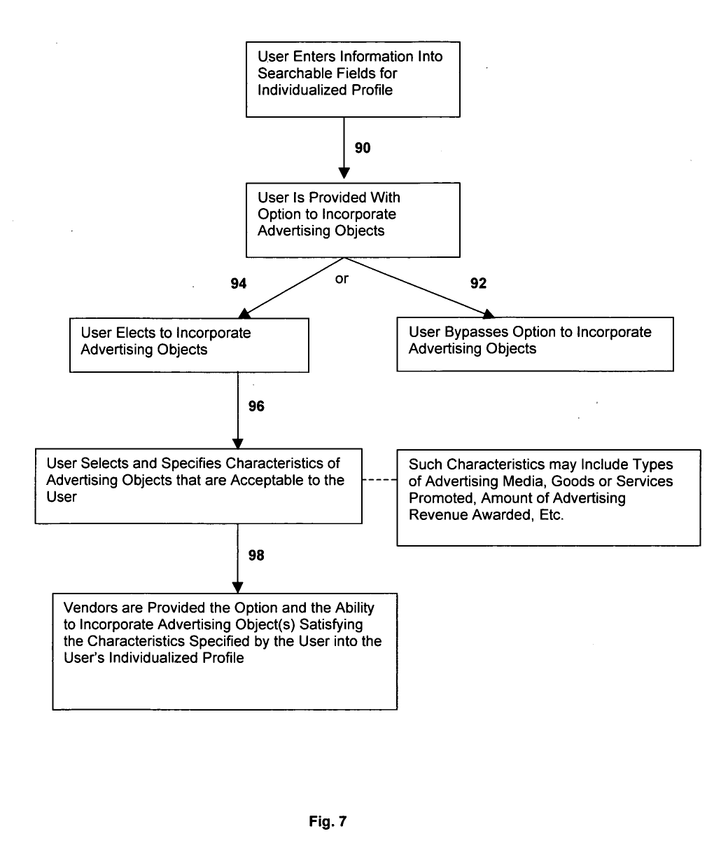

In addition to the above, the invention provides that the SNEATS server may enable users to provide vendors with the ability to incorporate one or more advertising objects into their individualized profiles. For example, referring to FIG. 7, a user may elect to allow vendors to incorporate advertising objects into their individualized profiles 94, wherein the users specify the types of advertising objects that are acceptable and/or unacceptable to such users 96. That is, users may expressly allow (and/or disallow) advertising objects to be incorporated into their individualized profiles if and only if such objects satisfy particular criteria. Examples of such criteria may be that a user will only allow specified vendors, or vendors from a particular industry, to incorporate advertising objects into his or her individualized profile. Similarly, such criteria may be that a user will only allow objects that (a) are correlated with advertising schemes that promote certain types of goods or services or utilize a particular type of media (e.g., images, flash files, secondary websites, etc.), (b) award advertising revenue in a certain way (e.g., whether a flat-fee is awarded upon incorporating an object or whether advertising revenue is dispersed on a “pay-per-click” basis), or (c) other characteristics that may be relevant to a user. After designating such criteria, vendors may incorporate advertising objects into the individualized profile of a user 98, provided that such advertising objects satisfy the criteria set by the user.

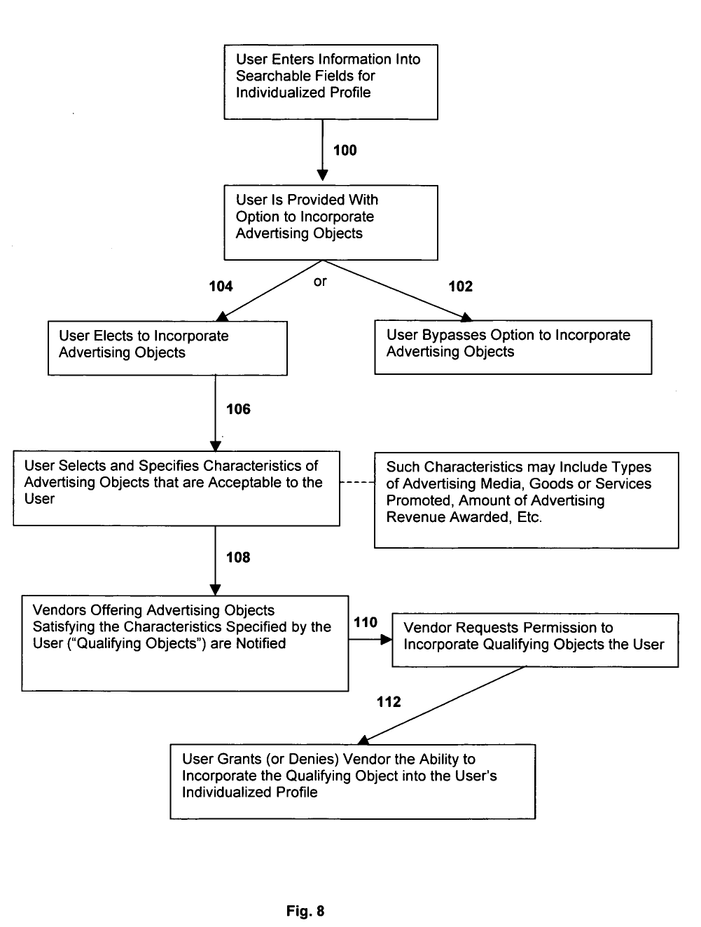

Still further, the SNEATS server may provide users with the opportunity to expressly accept the incorporation of a particular advertising object by a vendor—before such object is incorporated into his or her individualized profile. For example, referring to FIG. 8, if a user elects to allow vendors to incorporate one or more advertising objects into his or her individualized profile 104 (provided that such advertising objects satisfy the criteria specified by such user 106 (also referred to herein as “Qualifying Objects”)), the SNEATS server will require that a vendor seek the express consent of such user 110 before it is allowed to incorporate an advertising object into such user's individualized profile 112. Such notification 110 and express consent (or denial) 112 is managed by the SNEATS server. Furthermore, such notice may be provided to the user by way of e-mail and/or by publishing the notice within such user's advertising object account.

As mentioned above, the advertising revenue that is awarded to users in accordance with the present invention may be distributed by vendors or the owner/operator of the SNEATS server. For example, in one embodiment of the invention, a user is paid directly by the owner/operator of the SNEATS server (which in turn bills the appropriate vendors for the total amount paid to users for the aggregate number of instances that such vendors' advertising objects were activated). Alternatively, in another embodiment of the invention, a user is paid directly by the vendor that sponsored an advertising object, which is incorporated within such user's individualized profile. The means by which such payments are consummated may be facilitated by the SNEATS server. For example, in the case where a user is paid directly by a vendor, the SNEATS server may require that each vendor (i) provide the SNEATS server with a valid credit card number and other required information (and/or access to a bank account) and (ii) expressly consent to be charged for the total advertising revenue that must be paid to users, such that amounts owed to users are automatically dispersed (vis-à-vis each vendor's credit card or bank account), upon regularly scheduled payouts.

The invention further provides means by which the owner/operator of the SNEATS server may generate revenue. Similarly, in the event that the Social Networking System is hosted within the SNEATS server, the invention provides means by which the owner/operator of the Social Networking System may generate revenue. Still further, if the Social Networking System and SNEATS server are owned/operated by separate entities (and hosted within separate servers), arrangements may be made whereby such owners/operators may share revenue generated from the methods and systems described herein.

For example, the owner/operator of the SNEATS server may generate revenue by charging commissions on advertising revenue that is awarded to users. That is, the owner/operator of the SNEATS server may charge each user a defined percentage of the total advertising revenue awarded to each such user. In certain embodiments of the invention, such commissions are automatically deducted from the amounts paid to such users. For example, if a vendor owes a particular user one hundred dollars in advertising revenue, the owner/operator may charge the vendor's credit card one hundred dollars, retain ten dollars (i.e., a 10% commission charge), and pay the applicable user ninety dollars.

In addition, the invention provides that vendors may be required to pay a fee in order to incorporate advertising objects into individualized profiles. In a first example, a vendor may be required to pay a subscription fee to the owner/operator of the SNEATS server, which is due in regular intervals, such as monthly, quarterly, annually, etc., which entitles the vendor to incorporate advertising objects into individualized profiles as described herein. In a second example, a vendor may be required to pay transaction fees to the owner/operator of the SNEATS server, wherein the vendor is required to pay a flat-fee for each advertising object that is incorporated into an individualized profile.

The foregoing plainly shows the benefits provided by the present invention to users of Social Networking Systems, as well as the owners of such Social Networking Systems and SNEATS servers. Specifically, the invention provides new methods for owners and operators of Social Networking Systems to generate revenue. Similarly, the invention provides methods for users of Social Networking Systems to generate revenue, by turning portions of their individualized profiles into advertising space. Still further, it should be appreciated that the present invention provides vendors with new and creative ways of advertising in an on-line environment—an increasingly important venue for advertisers.

The invention provides that vendors may establish accounts with a SNEATS server using methods that are similar to those that may be used to establish an individualized profile (described above). For example, vendors may access a website associated with a SNEATS server and apply for an account using on-line forms. In such examples, the vendor may be required to enter company information into an on-line form, such as company name, mailing address, billing address, e-mail address, phone number, representative industry, and representative products. In addition, for the purpose of enabling payment of awarded advertising revenue, SNEATS server subscription fees, and SNEATS server transaction fees, the vendor may be required to enter a valid credit or debit card number (along with other necessary information, such as the expiration date of the card). In certain preferred embodiments of the invention, the SNEATS server maintains an on-line profile for each vendor, which displays the vendor-specific information described above. Furthermore, the on-line profile preferably includes an advertising object account for each vendor, which shows the number of advertising objects that have been incorporated into individualized profiles, the number of times that each advertising object used by the vendor has been activated, and the total amount of advertising revenue that is owed to users.

In certain embodiments of the invention, advertising schemes are designed by vendors and provided to a SNEATS server. For example, vendors may design advertising schemes consisting of a hyperlink (which is linked to a secondary website associated with the vendor), image, flash file, PDF file, audio clip, and/or video clip. Vendors may provide such advertising schemes to a SNEATS server by “uploading” an appropriate computer-readable file to the server through an on-line form.

Preferably, the on-line form implements a filter which determines whether each image, flash file, PDF file, audio clip, and/or video clip (each representing an advertising scheme) conforms to certain technical requirements, such as pixel dimensions, file type, and/or file size. For example, upon attempting to upload an image file representing an advertising scheme to a vendor's profile (i.e., advertising object account), the SNEATS server may automatically check the file size and determine if it meets certain minimum resolution thresholds, such as minimum pixel dimensions. In addition, the SNEATS server may check to ensure that the image does not exceed a maximum file size, such as 0.5 Mb, 1.0 Mb, 1.5 Mb, 2.0 Mb, or other limit. Still further, the SNEATS server may check to ensure that the image is in a preferred format. Non-limiting examples of currently-available formats include: Adobe Photoshop (.psd), AutoCAD (.dxf), CorelDraw (.cdr), Enhanced Metafile (.emf), EPS (.eps), FlashPix (.fpx), GIF (.gif), Home Publishing (.php), JPEG (.jpg), Kodak Photo CD (.pcd), Macintosh PICT (.pct), Micrografx Designer (.drw), PC Paintbrush (.pcx), Picture It! (.php, mix, and .fpx), PNG (.png), TIFF (.tif), Targa (.tga), Windows Bitmap (.bmp), and Windows Metafile (.wmf). The present invention, preferably, employs similar filters for a flash file, PDF file, audio clip, and/or video clip that a vendor attempts to upload to its profile within a SNEATS server.

In certain preferred embodiments of the invention, the advertising schemes that may be launched from an advertising object exhibit a standardized graphical user interface. There are many benefits associated with such standardization. For example, it creates uniformity among the advertising schemes launched from a plurality of advertising objects incorporated within various individualized profiles. Of course, such uniformity facilitates a quick and efficient review of an advertising scheme by users, while, in light of the multi-media aspects of such advertising schemes, simultaneously providing an entertaining experience to such users.

The terms “standardized” and “standardization” refer to, among other things, the graphical user interface of the advertising schemes that are used in the present invention. Those of ordinary skill in the art of web design (and related arts) will appreciate that numerous methods exist to achieve a substantially standardized graphical user interface among the various advertising schemes that may be launched from an individualized profile. For example, certain hypertext markup language (HTML) methods may be employed to construct frames, tables, cascading style sheets, or like elements within the graphical user interface, such that each advertising scheme resides within a defined and constant dimension of the website associated with the Social Networking System (regardless of whether such advertising scheme is represented by an image, flash file, or other media). In other embodiments of the invention, each type of media used to present an advertising scheme may have its own type of standardization. For example, advertising schemes represented by an image may comprise a defined set of pixel dimensions, whereas advertising schemes represented by a flash file may comprise a defined set of pixel dimensions which is different than the pixel dimensions for images.

In addition, certain embodiments of the invention provide that advertising schemes are launched within a specified section of the graphical user interface of individualized profiles. As used herein, the terms “sections” or “section” refer to the different parts of the graphical user interface which comprise individualized profiles, which may be constructed and implemented using any suitable means, such as HTML frames, tables, cascading style sheets, or like elements. In certain embodiments, upon uploading a desired advertising scheme, the SNEATS server provides the vendor with a realistic on-screen simulation of how the advertising scheme will look within an individualized profile (or website associated with the Social Networking System). Upon viewing the simulation, the vendor may approve (or disapprove and modify) the advertising scheme.

As mentioned above, an advertising scheme may further include one or more gift cards, gift certificates, and/or coupons. In certain embodiments, the SNEATS server (and website associated therewith) may provide its own template for generating such gift cards, gift certificates, and/or coupons. In such embodiments, the SNEATS server will incorporate authenticating information into each such gift card, gift certificate, and coupon. Alternatively, vendors may provide such gift cards, gift certificates, and/or coupons in the form of image files, PDF documents, or other media types, wherein the content and authenticating information is designed and implemented by such vendors without the aid of the SNEATS server.

The SNEATS server may require that a vendor specify certain information associated with each advertising scheme, such as the type of goods or services promoted by the advertising scheme. The SNEATS server makes this information available to users that may incorporate a corresponding advertising object into their individualized profiles, as described above.

In addition, the SNEATS server may require that a vendor specify whether it would like a particular advertising scheme (or, more particularly, the underlying advertising object) to be made available for users to directly incorporate into individualized profiles. The SNEATS server will require that each vendor specify, and agree to, the means by which each user will be awarded advertising revenue for each activation of an incorporated advertising object. In certain embodiments of the invention, vendors may enable only a select number of users to incorporate an advertising object into their individualized profile. For example, for an advertising object that launches an advertising scheme that promotes female-oriented products, the vendor may specify (and direct the SNEATS server) to only allow female users to incorporate such advertising object into their individualized profiles (wherein the vendor may assume that the majority of associate users that search for and view such individualized profiles will be other female users, thus enhancing the commercial impact of the advertising scheme).

In other embodiments, a vendor may designate an advertising scheme (and underlying advertising object) to be automatically incorporated into individualized profiles that satisfy the vendor's designated criteria, e.g., the gender, age, geographical residence, and profession of users. As described above, users may elect to allow vendors to directly incorporate advertising objects into their individualized profiles, provided that such advertising objects satisfy the user-specific criteria. Thus, in order for such advertising objects to be automatically incorporated into individualized profiles, the vendor- and user-specified criteria must both be satisfied. Still further, as discussed above, the invention provides that a user may require that he or she be notified that a vendor would like to incorporate an advertising object into his or her individualized profile (before such advertising object is incorporated therein). At such time, the user may grant or deny the vendor the ability to incorporate such advertising object into his or her individualized profile.

Preferably, the methods of providing advertising objects (and corresponding advertising schemes) to a SNEATS server further comprise requiring each vendor to review, acknowledge, and execute a legal agreement. Such requirements are preferred for several reasons, such as to set forth and document acceptable and unacceptable conduct and advertising scheme content and to shield the owner/operator of the SNEATS server from any liability which may arise from a vendor's use, creation, or publication of an advertising scheme using the SNEATS server.

The agreement, preferably, requires each such vendor to agree and represent that, among other things, (a) none of the text, images, video, audio, or other content provided to the SNEATS server infringes the copyright, trademark or patent of any third party or violates any law or regulation; (b) that such content (and the exploitation thereof will not violate the rights to privacy or publicity of any person or constitute a defamation against any person, or in any other way violate the rights of any person whomsoever; (c) that the vendor owns all rights to such content free and clear of any liens, encumbrances, and other third party interests, and any claims or litigation, whether pending or threatened; (d) that such content (nor any element thereof) is not pornographic, obscene, offensive to community standards, discriminatory, promotes violence or contains false advertising, hate speech or viruses, Trojan horses, worms, time bombs, cancelbots, or other harmful programming language; (e) that the vendor has the full right and power to make and perform the agreement without the consent of any third party; (f) that the vendor shall defend, indemnify and hold the owner/operator of the SNEATS server (including its employees and agents thereof), its licensees and assigns harmless from all claims, liabilities, damages, costs and reasonable legal fees and expenses arising from any breach or alleged breach of the agreement (or warranty or representation therein); (g) the vendor agrees to redeem, acknowledge, fulfill, and accept all gift cards, gift certificates, coupons, discounts, or other offers of any kind which may be incorporated within an advertising scheme, and (h) the vendor agrees to pay all advertising revenue owed to users for activation of advertising objects provided by such vendor. Preferably, the legal agreement is accessed, reviewed, acknowledged, and executed on-line within the website associated with the Social Networking Service and/or SNEATS server.

While the above has described in detail various aspects of the methods included within the present invention, further embodiments of the invention include systems that may be used to carry out such methods. In certain preferred embodiments, the systems comprise a Social Networking System that includes a plurality of users, a plurality of user terminals, and at least one server responsible for hosting the Social Networking System. The Social Networking System provides each of its users with individualized profiles, which are capable of incorporating at least one advertising object.

The systems further include at least one SNEATS server, wherein the SNEATS server (i) is capable of exchanging information with the server responsible for hosting the Social Networking System and (ii) provides each user of the Social Networking System with the ability to access and incorporate one or more advertising objects into his or her individualized profile. Similar to other embodiments of the invention, the Social Networking System may be hosted within the SNEATS server, or in a separate server that is capable of exchanging information, directly or indirectly, with the SNEATS server. The system further provides a mechanism by which a user is awarded advertising revenue in the event that he or she incorporates one or more advertising objects into his or her individualized profile (and/or such advertising object is activated by associate users as described above).

It should be appreciated that numerous applications exist for the on-line methods and systems described, contemplated, or suggested herein. For example, the present invention may used by a variety of businesses to advertise products in a unique, effective, manageable, and affordable manner. It should be appreciated that the on-line methods of advertising provided by the present invention will also benefit service providers. Indeed, the methods described herein may be useful in the advertisement of professional services, such as real estate services, accounting services, financial advisory services, engineering services, consulting services, computer services, sales services, construction services, entertainment services, and health care services.

The following Examples are provided to further illustrate certain aspects of the present invention. Importantly, the invention is not limited to the exact methods and embodiments described and shown below.

### EXAMPLES

### Example 1—Creating an Individualized Profile

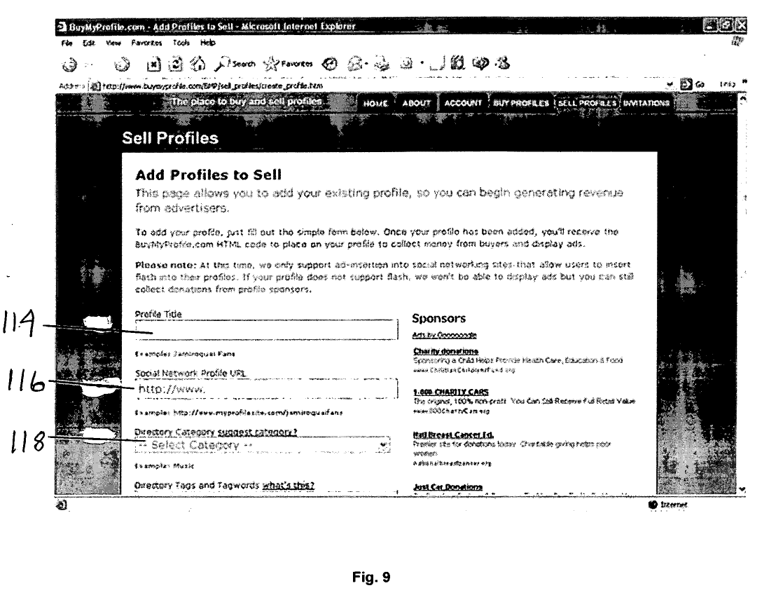

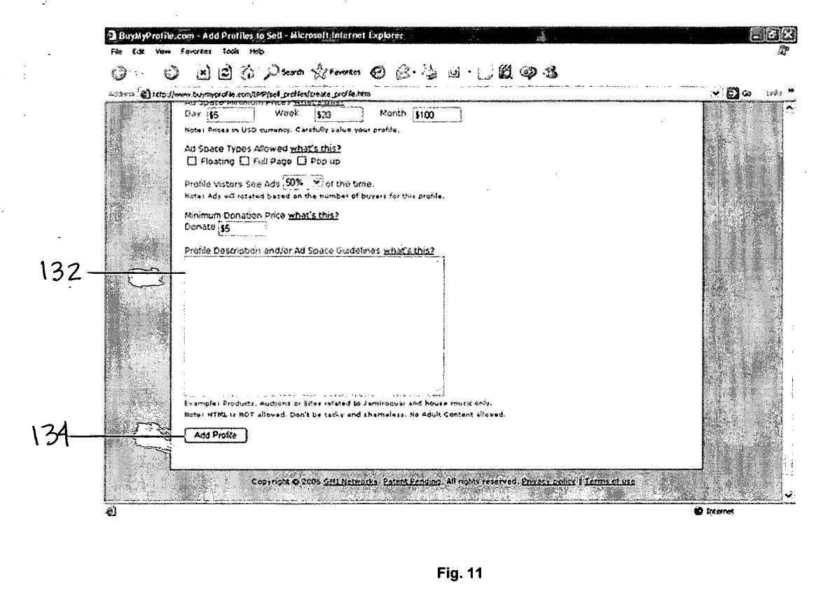

FIGS. 9, 10, and 11 illustrate non-limiting examples of a graphical user interface (i.e., a website) that may be used to establish an individualized profile. Referring to FIG. 9, each user may assign a “Profile Title” 114 and Social Network Profile uniform resource locator (“URL”) 116 to his or her individualized profile. In addition, each user may select an appropriate category, or “directory category,” 118 for his or her individualized profile. Preferably, each user will select a directory category from a predefined list, which may include a plurality of different categories spanning a wide variety of interests, topics, and personalities. For example, such categories may include, but are not limited to, arts & culture, autos & vehicles, businesses, education & instructional, employment, entertainment, events & parties, food & drink, fashion & clothing, auctions, government & legal, gay & lesbian, health & fitness, hobby & interests, humor & comedy, movies, music, news & politics, charity, “odd & outrageous”, other, people & personalities, personal, personals & dating, pets & animals, real estate, religion & philosophy, restaurants, science & technology, sports, stores & retail, travel & places, video games, and weddings & family.

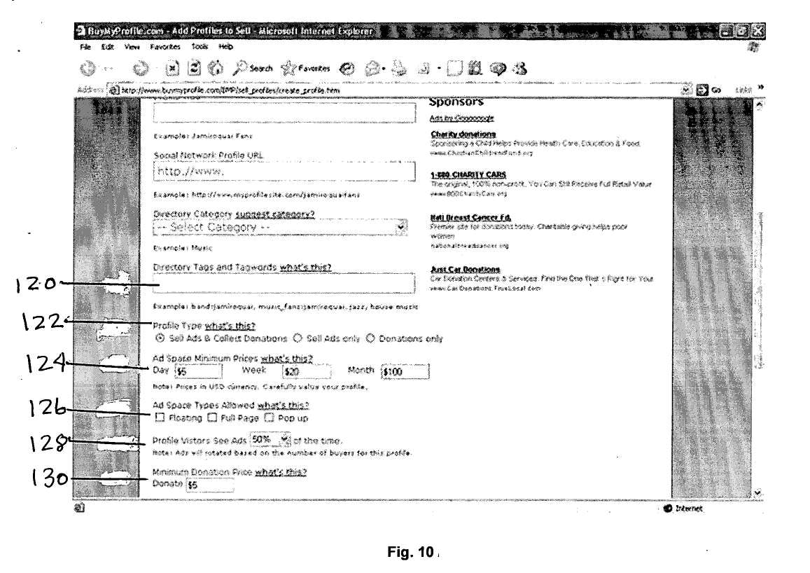

Referring to FIG. 10, each user may provide the Social Networking Systems server (and/or SNEATS server) with preferred “Directory Tags” and “Tagwords” 120. In general, “Directory Tags” and “Tagwords” use a combination of tags and keywords to provide a refined searchable list to enable potential buyers of advertising space, and/or other users of the Social Networking System, to find relevant individualized profiles. In other words, the “Directory Tags” and “Tagwords” specified by each user provide a list of key words that are considered when advertisers and/or other users of the Social Networking System search for particular types of users. For example, the Tagword “band” may be joined with the keyword “Jamiroquai” to make “Band:Jamiroquai,” which may be designed to attract advertisers and/or other users who are interested in bands or Jamiroquai fans.

In certain embodiments of the present invention, each user may further select the type of individualized profile that he or she desires 122. For example, each user may specify whether he or she desires to (i) only “sell” advertising space to third party vendors, (ii) only allow philanthropic and/or charitable organizations to use his or her individualized profile to solicit and accept donations, or (iii) a combination of the foregoing. In certain preferred embodiments of the invention, each user is allowed to specify the minimum prices 124 that he or she will accept in exchange for advertising within his or her individualized profile. Such minimum prices may be itemized into different time periods, thereby allowing users to specify a minimum fee for advertising within his or her profile for a single day, week, month, or year.

Preferably, the invention allows users to freely modify the minimum prices 124 that they set. In certain embodiments of the invention, vendors are allowed to match and/or exceed the minimum prices 124 set by a particular user. The extent to which vendors exceed a user's minimum price 124 may influence the frequency with which a particular advertising object is published within a user's profile. For example, if two vendors purchase advertising space within a particular user's profile, and one of the two vendors agreed to pay a premium for such advertising (i.e., an amount over the user's minimum price 124), the advertising object (and corresponding advertising scheme) for such vendor will be displayed more frequently than the other vendor, which paid the minimum required 124.

Still further, the invention may provide each user with the ability to specify the types of advertising schemes that may be launched from his or her individualized profile. Referring to FIG. 10, for example, each user may specify whether “floating ads”, “full page” websites, “pop up” ads, or a combination of the foregoing are acceptable 126. In addition, in certain embodiments of the invention, each user may specify how often advertising objects may be displayed within his or her individualized profile 128, e.g., 25%, 50%, 75%, or 100% of the visits to his or her profile.

It is contemplated that the individualized profiles of the present invention may be used to solicit and accept donations for charitable and/or philanthropic causes. In such cases, each user may further specify a minimum donation 130 that vendors or other users may submit to support a worthy cause that is described in a user's individualized profile.

Finally, the invention may allow users to enter certain “Profile Description” and/or “Ad Space Guidelines” 132. This may be achieved, for example, by allowing such users to enter “free text” into a text box, in which users may specify, in their own words, the types of advertising objects/schemes that are unacceptable to them. For example, a user may specify, in his or her own words 132, that ads relating to fashion or a particular type of music are unacceptable. Here again, the invention provides unparalleled flexibility in allowing users to dictate the types of goods and services that may be advertised within their personal cyberspace.

As shown in FIGS. 9, 10, and 11, the information provided by each user during the process of applying for and establishing an individualized profile may be collected using on-line forms. After entering such information, and/or making the necessary selections (described above), each user's information may be submitted (i.e., provided to) 134 the Social Networking Systems server and/or SNEATS server. Such commands are typically carried out using “submit” buttons and the like. As described earlier, depending on the network architecture used, the Social Networking System server and SNEATS server may reside within the same or different servers.

### Example 2—Certifying an Individualized Profile

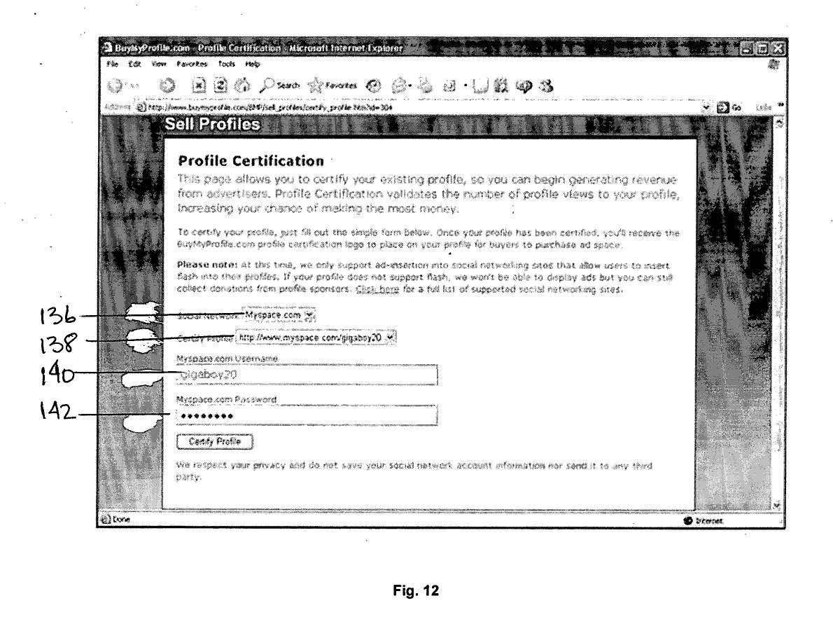

Referring to FIG. 12, the invention preferably provides each user with the ability to validate/certify his or her individualized profile. FIG. 12 provides a non-limiting example of a graphical user interface in which a user identifies (i) the Social Networking System 136 with which his or her individualized profile will be associated (e.g., myspace.com, friendster.com, tribe.net, etc.), (ii) the URL of his or her individualized profile 138 (located within the specified Social Networking System 136), and (iii) his or her username 140 and password 142 for such individualized profile 138. The invention provides that each user will identify the Social Networking System(s) 136 with which his or her individualized profile will be associated from a predefined list. This way, the predefined list will include only Social Networking Systems 136 that include or have registered access with a SNEATS server.

### Example 3—Selling Advertising Space Within Individualized Profiles

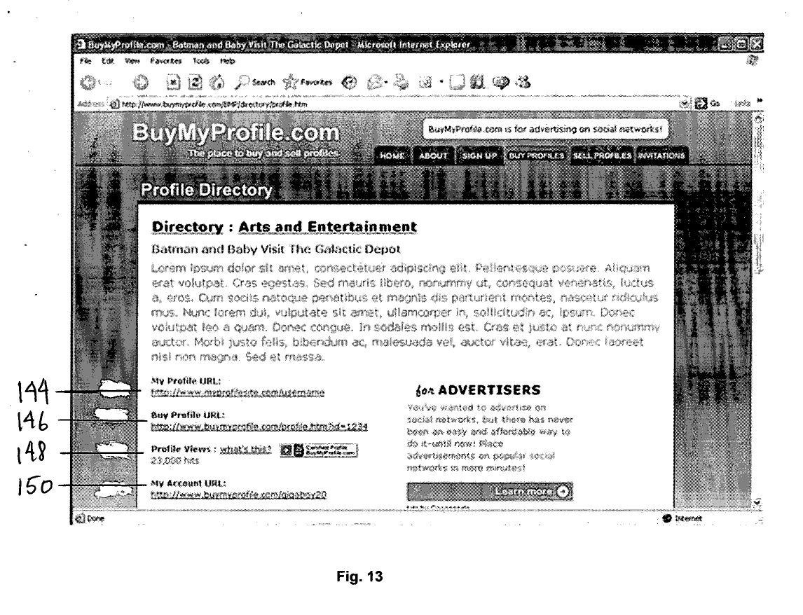

The invention provides truly innovative ways for vendors to reach new audiences and advertise goods and services. Referring to FIGS. 13, 14, and 15, the invention may allow each user, once he or she has established an individualized profile, to sell advertising space to third party vendors, preferably using a concise description of the terms and conditions mandated by such user. To begin, referring to FIG. 13, such description may include the URL 144 for the individualized profile, which will allow potential buyers to visit the individualized profile and enable such buyers to determine whether they wish to purchase advertising space therein. In addition, the description may include a link 146 that takes the visitor to a website in which advertising space located within the user's profile may be purchased; a tracking number which shows the number of users that have visited the individualized profile 148 (this will assist buyers in gauging the amount of web traffic that a particular individualized profile experiences and, therefore, the relative commercial value of advertising within such space); and/or a link 150 taking visitors to an “account page” for the user associated with the individualized profile.

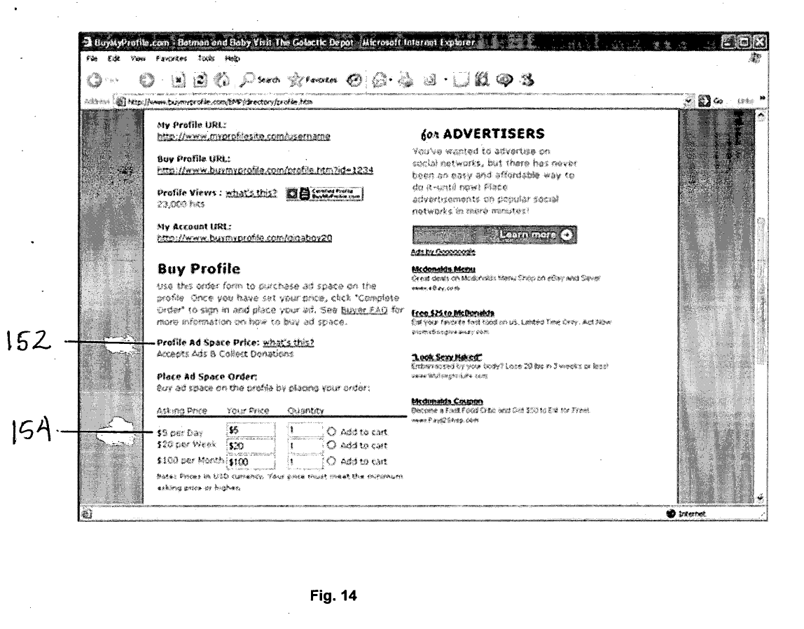

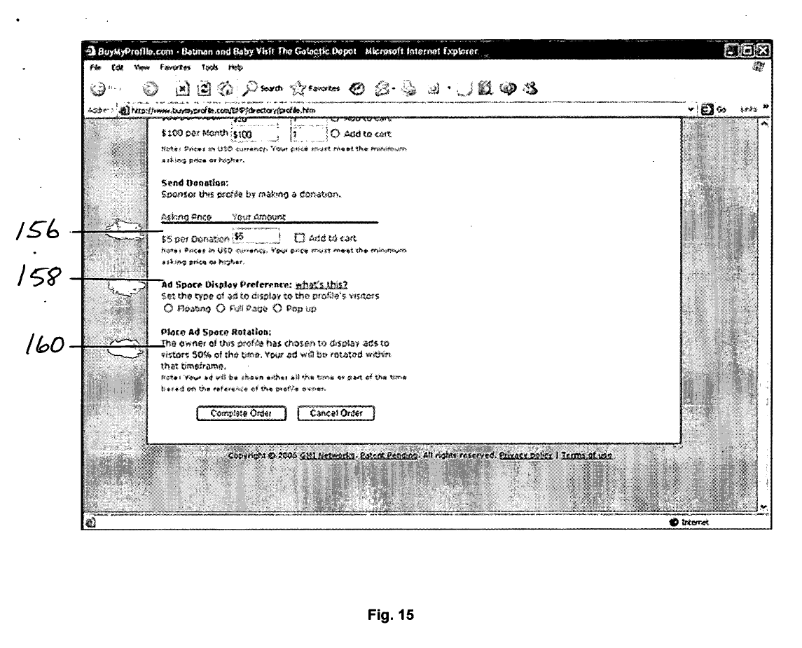

Importantly, referring to FIGS. 14 and 15, a description of each user's terms and conditions may be displayed within a webpage correlated with a particular user, which lists the user's minimum advertising price 154, the types of advertising schemes that are acceptable to such user 158, and the relative frequency that ads will be displayed within the user's individualized profile 160, etc. In addition, as discussed above, the invention provides means for conducting philanthropic and charitable activity within such individualized profiles. Thus, such description may further indicate whether a user also accepts donations 152 for a particular cause and, if so, the preferred minimum donation 156.

### Example 4—Searching For Desirable Advertising Space

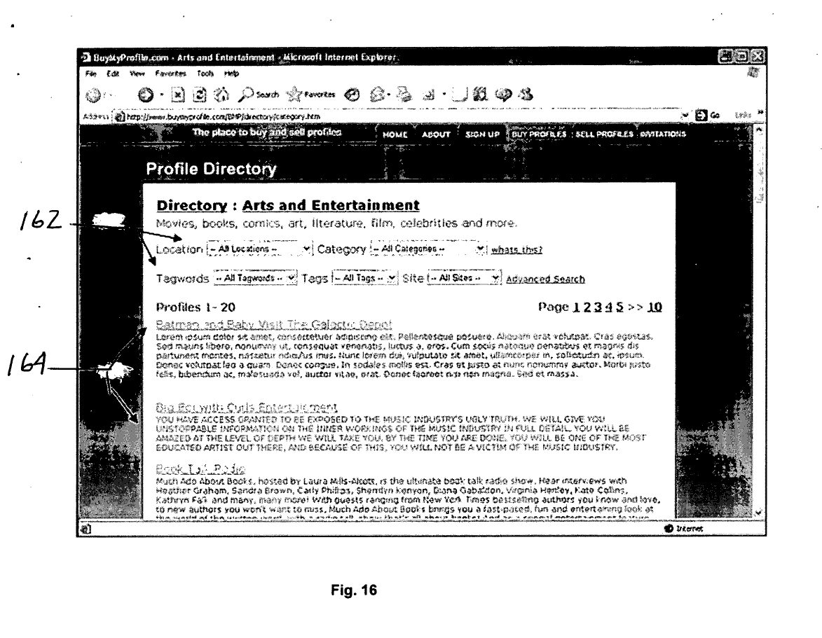

The invention provides vendors (i.e., purchasers of advertising space within individualized profiles) with means for navigating, searching for, and selecting desirable individualized profile space in which to advertise. For example, referring to FIG. 16, the invention may provide a graphical user interface in the form of a menu, which lists multiple individualized profiles 164 in which vendors may advertise. Preferably, the menu includes a link for each individualized profile that, upon selecting (or “clicking”) the link, transfers the visitor/potential purchaser to a concise description of the terms and conditions mandated by applicable user, such as described in Example 3 above and FIGS. 13, 14, and 15. In addition, in certain embodiments of the invention, each listing for each individualized profile 164 includes a brief description of the user associated with each individualized profile, in order to facilitate and expedite a potential purchaser's review of the menu of profiles.

In certain embodiments, the menu (or directory) of available individualized profiles in which a vendor may advertise is searchable 162. For example, referring to FIG. 16, a potential purchaser may search for individualized profiles based on (i) geographical location, (ii) directory categories (such as those described in Example 1 above), (iii) Tagwords, (iv) Tags, (v) Social Networking Systems, (vi) combinations of the foregoing, and/or (vii) other relevant variables (not necessarily shown or described herein). Preferably, the invention provides means for enabling potential purchasers of advertising space to efficiently and quickly identify individualized profiles that may be attractive targets in which to advertise.

### Example 5—Directory of Individualized Profiles

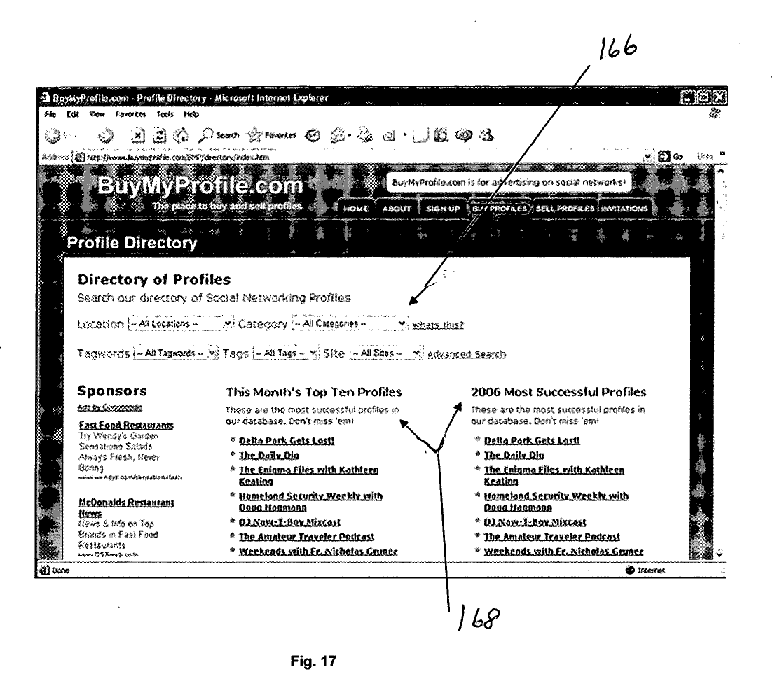

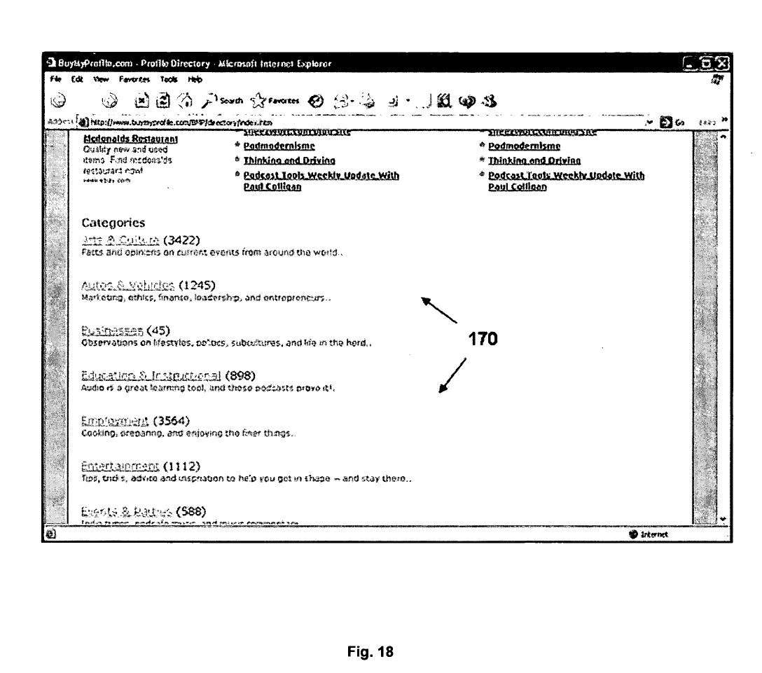

Of course, any of numerous means could be used to navigate, search for, and access the various individualized profiles that comprise a Social Networking System of the present invention. Importantly, the invention is not limited to a particular approach, method, user interface, etc. For purposes of illustration only, FIGS. 17 and 18 provide a non-limiting example of a user interface that enables users to search for and view the individualized profiles described herein. As shown in FIG. 17, a directory of individualized profiles may used, wherein the contents of the directory (and the various individualized profiles that are included therein) may be searched 166 based on, for example, (i) geographical location, (ii) directory categories (such as those described in Example 1 above), (iii) Tagwords, (iv) Tags, (v) Social Networking Systems, (vi) combinations of the foregoing, and/or (vii) other relevant variables (not necessarily shown or described herein).

Upon conducting a search, a menu of relevant individualized profiles 164 may be presented and accessed (such as described in Example 4). Preferably, the menu includes a link for each individualized profile that, upon selecting (or “clicking”) the link, transfers the visitor to the applicable individualized profile. In addition, in certain embodiments of the invention, each listing for each individualized profile 164, within the menu of search results, includes a very brief description of the user associated with each individualized profile, in order to facilitate and expedite a visitor's review of the menu of profiles. The graphical user interface may include various statistics about the individualized profiles within the directory 168, such as the “Month's Top Ten Profiles” or the “Most Successful Profiles.” In addition, the graphical user interface may allow visitors to browse the various categories, subcategories, and individualized profiles that comprise a directory 170 (i.e., Social Networking System).

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

1. A method of advertising within a social networking system, which comprises:
(a) providing a social networking system having a plurality of users and at least one server responsible for hosting the social networking system, wherein the social networking system provides each of said users with individualized profiles capable of incorporating at least one advertising object therein; and
(b) providing at least one SNEATS server, wherein the SNEATS server (i) is capable of exchanging information with the server responsible for hosting the social networking system and (ii) allows third party vendors to incorporate advertising objects into the individualized profiles of said users.

2. The method of claim 1, wherein each of said users may specify characteristics of the advertising objects that may be incorporated into the individualized profiles of such users, wherein said characteristics include the minimum advertising revenue awarded for incorporation of such advertising objects into said individualized profiles.

3. The method of claim 2, wherein the advertising objects are sponsored by a plurality of vendors.

4. The method of claim 3, wherein the characteristics of the advertising objects specified by each of said users further includes (a) the type of goods or services promoted by the advertising objects, (b) the medium used to convey a promotion of goods or services, and (c) the frequency that such advertising objects will be displayed within said individualized profiles.

5. The method of claim 4, wherein upon incorporating an advertising object into an individualized profile, at least a majority of the users of the social networking system may view and activate the desired advertising object within the individualized profile.

6. The method of claim 5, wherein the individualized profile comprises a plurality of searchable fields.

7. The method of claim 6, wherein the plurality of searchable fields includes user-specific information, wherein such user-specific information comprises one or more of the following: first name, last name, username for accessing the social networking system, gender, age, area of residence, profession, and description of interests.

8. The method of claim 7, wherein the individualized profile may be found by users of the social networking system by conducting keyword searches, wherein the keyword searches query the searchable fields including user-specific information.

9. The method of claim 5, wherein upon a user activating an advertising object incorporated within an individualized profile, an advertising scheme is initiated, wherein the advertising scheme conveys a message to the user through a medium selected from the group consisting of a text box, an image, an animation clip, a flash file, a video clip, an audio clip, a separate website, a “pop up” ad, or any combination of the foregoing.

10. The method of claim 5, wherein the SNEATS server is capable of maintaining a record of each time an advertising object is activated.

11. The method of claim 10, wherein the user associated with the individualized profile containing the activated advertising object is awarded advertising revenue.

12. The method of claim 11, wherein the awarded advertising revenue is calculated on a “pay-per-click” basis for each activation of the advertising object.

13. The method of claim 11, wherein the user associated with the individualized profile containing the activated advertising object is awarded a one-time advertising fee, wherein the one-time advertising fee becomes due when the third party vendor incorporates the advertising object into the individualized profile.

14. The method of claim 13, wherein the one-time advertising fee pays for the incorporation of the advertising object into the individualized profile for a defined period of time.

15. A method of advertising within a social networking system, which comprises providing a social networking system with a SNEATS server that is capable of:
(a) hosting and managing the social networking system, wherein the social networking system comprises a plurality of users, wherein each of said users is provided with an individualized profile capable of incorporating at least one advertising object therein;
(b) enabling third party vendors to incorporate at least one advertising object hosted on the SNEATS server into the individualized profile;
(c) allowing at least a majority of the users of the social networking system to view and activate the incorporated advertising object within the individualized profile; and
(d) recording each activation of such advertising object, wherein the user associated with the individualized profile containing the activated advertising object is awarded advertising revenue.

16. A system for advertising within a social networking system, which comprises:
(a) a social networking system comprising at least one server responsible for hosting the social networking system, wherein the social networking system provides users thereof with individualized profiles capable of incorporating at least one advertising object therein; and
(b) at least one SNEATS server, wherein the SNEATS server (i) is capable of exchanging information with the server responsible for hosting the social networking system and (ii) allows third party vendors to incorporate advertising objects into one or more individualized profiles of the social networking system.

17. The system of claim 16, wherein each of said users may specify characteristics of the advertising objects that may be incorporated into the individualized profiles of such users, wherein said characteristics include the types of goods or services promoted or the minimum advertising revenue awarded for incorporation of such advertising objects.

18. The system of claim 17, wherein the advertising objects are sponsored by a plurality of vendors.

19. The system of claim 18, wherein upon incorporating an advertising object into an individualized profile, at least a majority of the users of the social networking system may view and activate the desired advertising object within the individualized profile.

20. The system of claim 19, wherein the user associated with the individualized profile containing the activated advertising object is awarded advertising revenue.
